(19) United States
(12) Patent Application Publication
(10) Pub. No.: US 2006/0009148 A1
(43) Pub. Date: Jan. 12, 2006

(54) Module of conveying and distributing air originating from a thermal unit of a heating, ventilation and/or air conditioning system for the cockpit of a vehicle

(75) Inventors: Eric Droulez, Suresnes (FR); Serge Pouysegur, Le Perray en Yvelines (FR); Franck Truillet, Rueil Malmaison (FR)

Correspondence Address: Valeo Climate Control Corp.;Intellectual Property Dept., 4100 North Atlantic Boulevard, Auburn Hills, MI, 48326, US

(73) Assignee: Valeo Climatisation S.A., La Verriere (FR)

(21) Appl. No.: 11/175,949

(22) Filed: Jul. 6, 2005

(30) Foreign Application Priority Data
Jul. 7, 2004 (FR) 04 07559

(51) Int. Cl. B60S 1/54

(52) U.S. Cl. 454/121

(57) ABSTRACT

The subject of the invention is a module for conveying and distributing air originating from a thermal unit of a heating, ventilating and/or air conditioning system system for the cockpit of a vehicle. This module comprises a partitioned box structure (3) which delimits a number of ducts allocated respectively to the supply of air to zones of the cockpit. This box structure (3), installed inside a front transverse beam of the cockpit, delimits an overall intake duct (4) which is in communication with a duct (5) supplying air originating from the thermal unit. This overall duct (4) is equipped with at least one main splitter (6) for distributing the admitted air selectively towards main distribution ducts (7, 8) which are in communication via respective outlets with a said zone of the cockpit to which these outlets are assigned.

### TECHNICAL FIELD OF THE INVENTION

The invention is of the field of heating, ventilation and/or air conditioning systems for the cockpit of a vehicle. Its subject is a module for conveying and distributing air originating from a thermal unit towards varied zones in the cockpit of the vehicle.

### TECHNICAL FIELD OF THE INVENTION

It is recalled that a heating, ventilation and/or air conditioning system for the cockpit of a vehicle employs a thermal unit and a blower in order to cause air to circulate through the thermal unit, then through the air conveying and distribution ducts assigned to various zones of the cockpit. These zones of the cockpit correspond in particular to the deicing of the windshield and to the demisting of the side windows, and to front and rear zones. The front zones usually comprise zones for ventilating the seat, central and lateral right and left zones, and zones for ventilating the users' feet. The rear zones for their part comprise zones for ventilating the seat and zones for ventilating the occupants' feet. There is another auxiliary functionality that is sought, and that is to allow air to be diffused gently inside the cockpit, through specific vents.

### STATE OF THE ART

One problem that has presented itself lies in the overall organization of the means employed to convey and distribute air selectively to one and/or other of the zones of the cockpit.

It is common practice to use the presence of a structural element of the cockpit, such as an instrument panel and/or a front transverse beam, for the passage of ducts for conveying air to the various zones of the cockpit that need to be ventilated, to which the ducts are assigned. Selection means that can be operated by the passengers of the vehicle from the cockpit allow air to be distributed to one and/or the other of these ducts.

One difficulty which needs to be overcome lies in organizing both the ducts and the means for selecting the distribution of air, which need to have the smallest possible bulk, while at the same time being easy to install in the cockpit. The desirable benefit of it being easy for such an organization to be incorporated into any cockpit, or even into any relatively arbitrary zone of a cockpit and of it being of a simple and lightweight structure should also be noted. Furthermore, the means employed for conveying and distributing the air must not, for a given volume, give rise to pressure drops or prohibitive noise pollution. Furthermore, the organization of these means must not adversely affect the simplicity of their use by the passengers in order to select the desired distribution of air and must take account of the constraints associated with a distribution of air that is potentially tailored to the heat exchange capabilities achieved at that point in time. Finally, the organization of these means must not have an adverse effect on the structural elements of the cockpit having appropriate mechanical strength.

As a result of this, designers having intuitively to look for a compromise capable of reconciling all these various constraints in order best to organize the means for conveying and selectively distributing the air.

### SUBJECT OF THE INVENTION

The object of the present invention falls within the context of this search for a compromise, and proposes a module for conveying and distributing air originating from a thermal unit of a heating, ventilation and/or air conditioning system for the cockpit of a vehicle which offers solutions that are satisfactory with respect to such a comprise.

The inventive approach of the present invention consisted overall in organizing an air conveying and distribution module in the form of at least one partitioned box structure, advantageously one that could be incorporated into a structural element of the cockpit of the vehicle, such as a transverse reinforcing beam of the cockpit of a vehicle, or even an instrument panel. It will be understood that the module of the present invention is an independent functional unit for distributing air to various zones of the cockpit of the vehicle, which is in communication with the thermal unit of the system, and can itself advantageously be incorporated into the structural element.

This box structure comprises an overall air intake duct for air originating from the thermal unit, which then subdivides into various ducts assigned respectively to supplying air firstly to the deicing of the windshield and the demisting of the side windows, and secondly to the front zones or even the rear zones. A splitter, mounted so that it can move within the box structure, is placed in the path of the overall duct so as to distribute the air towards one or other of the ducts assigned to supplying these zones of the cockpit with air.

The overall duct constitutes a common air intake chamber for all the front zones that are to be ventilated, particularly those of a first group comprising the central and lateral zones and possibly also the footwell zone, and those of a second group comprising the deicing of the windshield and the demisting of the side windows, and possible even gentle diffusion. This overall duct is in communication with main ducts which are assigned respectively to the supply of air to each of these groups, a main splitter for selecting the passage of the air, operating either in on/off mode or in progressive air distribution mode, being interposed between the main ducts. It should be noted at this stage in the description that such a splitter may consist of a common mains splitter or be subdivided into two main elementary splitters assigned respectively to each of the main ducts. As far as the supply of air to the rear zones is concerned, the box structure is also used to allow air to be conveyed towards the rear seat and footwell zones, for example.

According to a first variant, the overall duct is subdivided into two, first and second, elementary ducts assigned respectively to the supply of air to the front zones, both of the first group and those of the second group in the manner of the aforementioned corresponding arrangements, and to the supply of air to the rear zones, both seat and footwell.

It will be understood that according to such an embodiment, each elementary duct constitutes an overall supply duct for supplying all the respective front and rear zones.

It will be noted that it is preferable to isolate the air supply to the front footwell zones from the air supply to the other front zones by placing a secondary selective air distribution splitter between a first intermediate duct assigned to supplying air to the first group of front zones and a second intermediate duct assigned to supplying air to the front footwell zone.

According to a second variant, the supply of air to the rear zone is performed from the main duct assigned to supplying air to the first aforementioned group of front zones. In this case, and according to a specific embodiment variant, it is optionally proposed for the air supply to the front and rear footwell zones to be isolated from the air supplies to the other front and rear zones. To do this, an additional splitter is placed at the outlet of the overall duct, upstream of the main splitter, to selectively distribute air either in an on/off fashion or as a progressive distribution of air, to the additional ducts respectively assigned to supplying air to the main ducts on the one hand and to the front and rear footwell zones on the other.

According to another aspect of the present invention, it is also proposed for the box structure to be used to allow also gentle diffusion of air through the specific ducts. This gentle diffusion is preferably supplied with air from the first main duct, and more particularly from the air supply for deicing the windshield.

It will be noted that the invention also relates to the incorporation of an independent aforementioned module into a structural element of the cockpit of a vehicle, and more particularly into a reinforcing beam or an instrument panel. Such a structural element, beam and/or panel, is chiefly recognizable in that it is equipped with means for accommodating the box structure within its internal volume, and in that it comprises, through its walls, apertures for the passage of the air, both the intake air and the discharge air to the vents, which are in communication with the various ducts that the box structure has, particularly those mentioned.

There then arises the problem of mounting a box structure of the present invention within a structural element such as that constituted by a reinforcing beam of the cockpit of the vehicle. To allow such ease of mounting, it is advantageously proposed for the box structure to be made up of a plurality of shells assembled with one another. Such a shell structure of the box structure allows the latter to be introduced into the beam from its ends, to then finally allow the box structure to be mounted inside the beam without in any way affecting the integrity of its mechanical strength.

More specifically, the shells are divided into elements these being respectively at least a right end element and a left end element, and possibly also a middle element, which are butted together longitudinally.

When the beam comprises an obstacle to the longitudinal circulation of the shells within the beam, such as a recess for the passage of part of the vehicle, more specifically a steering column or an airbag, it is particularly proposed for there to be produced, in at least one of the elements that make up the box structure, particularly in an end element, at least one narrowed region for the passage of this obstacle.

When this narrowed region is situated in a central zone of a first element, the latter is advantageously split into two longitudinally open half shells one of which comprises the narrowed region. These measures are such that the half shell comprising the narrowed region can be introduced and installed inside the beam notwithstanding the presence of the obstacle that the latter comprises, the other half shell then being introduced and installed inside the beam.

To facilitate blind assembly inside the beam of the two half shells with one another, it is preferably proposed for the edges of the openings of the half shells to be longitudinally inclined.

In particular, the half shells comprise, along the edge of their longitudinal openings, collaborating nesting members for assembling them with one another.

The collaborating nesting members particularly consist of a set of slideways and collaborating rails, or similar nesting members, which are formed respectively along the longitudinal edges of the openings of the half shells to facilitate their relative guidance when they are being assembled.

As a preference, the nesting members have collaborating faces that are non-parallel so as to encourage the clamping and leaktightness of the assembly of the half shells with one another.

With the narrowed region situated in an end zone of an element, for the passage of an airbag for example, this element is formed with equal preference either from just one or from several shells.

According to a particular embodiment variant, two adjacent elements comprise a narrowed region that is adjacent from one of the elements to the other so as jointly to delimit a housing for the passage of a part of the vehicle especially to jointly house an airbag, a computer, a glove box or some other part of the vehicle usually positioned in this zone of the cockpit.

As a preference, the box structure comprises at least one end tip shell for closing off its corresponding end. This end tip shell is advantageously put to use to form an internal partitioning of the box structure. More particularly, this end tip shell comprises at least one flange for partitioning at least one other shell, so as to form at least one internal duct inside the box structure.

It will be noted that, in order to fix the shells inside the beam, these shells comprise, for example, holes for the passage of fasteners for fastening the shells to the beam.

### DESCRIPTION OF THE FIGURES

The present invention will be better understood from reading the description thereof which will be given of some preferred embodiments, in conjunction with the figures of the attached plates, in which:

FIG. 1 is a diagram illustrating an example of the installation of a module of the present invention inside a transverse beam of a cockpit of a vehicle.

FIG. 2 is a diagram illustrating the organization of a module of the present invention according to preferred embodiments.

FIG. 3 is a diagram illustrating a first embodiment variant of a module of the present invention.

FIG. 4 and FIG. 5 are illustrations of a module according to the embodiment variant depicted in FIG. 3, viewed from above and viewed from the side, respectively.

FIG. 6 is a diagram illustrating a second embodiment variant of a module of the present invention.

FIG. 7, FIG. 8 and FIG. 9 are illustrations of a module according to the embodiment variant depicted in FIG. 6, in perspective, in a side view and in a view from above, respectively.

FIG. 10 is a diagram illustrating a third embodiment variant of a module of the present invention.

FIG. 11, FIG. 12 and FIG. 13 are illustrations of a module according to the embodiment variant depicted in FIG. 10, in a side view, a view from above and in cross section, respectively.

FIG. 14 is a diagram illustrating a fourth embodiment variant of a module of the present invention.

FIG. 15, FIG. 16 and FIG. 17 are illustrations of a module according to the embodiment variant depicted in FIG. 14, in a side view, a view from above, and in cross section, respectively.

FIG. 18 is an illustration in section of a box structure that a module of the present invention comprises, installed inside a reinforcing beam of the cockpit of the vehicle.

FIG. 19 is an exploded perspective illustration of a preferred embodiment of a box structure depicted in FIG. 18.

FIG. 20 is an illustration in section of the modes of assembly with one another of two half shells that the box section depicted in FIG. 19 comprises.

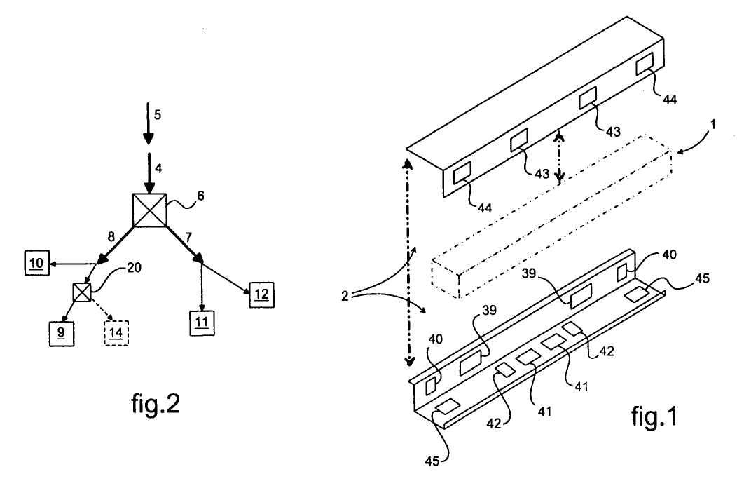

In FIG. 1, a module 1 for conveying and distributing air originating from a thermal unit of a heating, ventilation and/or air conditioning system is particularly intended to be installed inside a structural element 2 of a cockpit of a vehicle, a front transverse structural beam or instrument panel in particular. Referring also to the other figures, this module is chiefly recognizable in that it comprises at least one partition box structure, such as 3, which delimits a plurality of ducts assigned respectively to supplying air to zones of the cockpit. It will be noted at this stage in the description of the embodiments illustrated that the box structures 3 that make up the module of the invention are two in number, these being arranged respectively in the right and left zones of the structural element 2. The box structure 3 more particularly delimits an overall intake duct 4 which is in communication with the thermal unit, via, for example, an air supply duct 5. This overall duct 4 is equipped with at least one main splitter 6, or similar member, for distributing the air admitted selectively towards main distribution ducts 7 and 8. The latter 7 and 8 are in communication via respective outlets with at least one of said zones of the cockpit to which these outlets are assigned. It will be understood that these outlets correspond to the corresponding orifices of ducts placed in communication with the various ducts in the box structure in order to convey air towards those zones of the cockpit that are to be ventilated.

The main ducts 7 and 8 are preferably at least distributed as a first main duct 8 assigned at least to supplying air for deicing the windshield 9 and demisting 10 the side windows, and a second main duct 7 assigned at least to supplying air to the front zone of the cockpit, particularly the central 11 and lateral 12 zones of the front seats.

According to another aspect of the present invention, the first main duct 8 which is, in particular, assigned at least to supplying air for deicing the windshield 9, may also be assigned to supplying air for gentle diffusion 14.

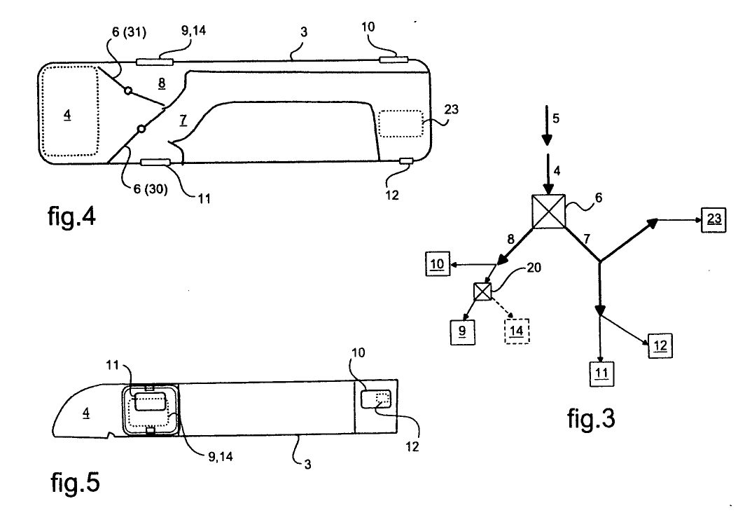

In the embodiment variant illustrated in FIG. 3 to FIG. 5, the second main duct 7 is also assigned to supplying air to the rear ventilation zone 23 of the cockpit.

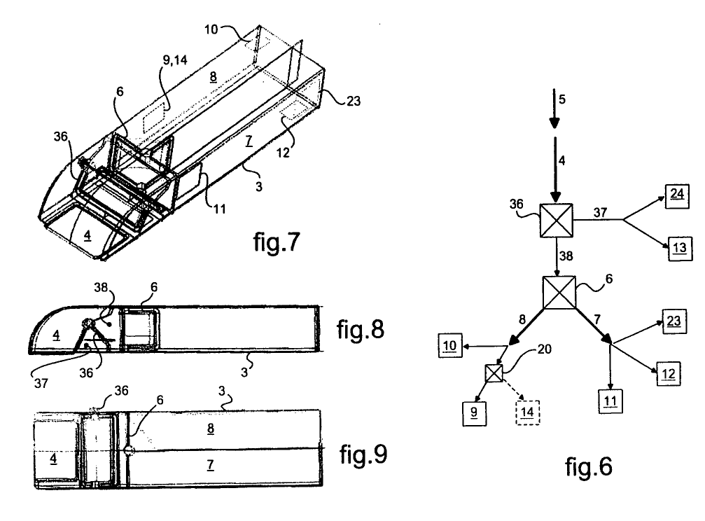

In the embodiment variant illustrated in FIG. 6 to FIG. 9, the overall duct 4 is in selective communication, via an additional splitter 36, with additional ducts 37 and 38. A first additional duct 37 is assigned to distributing air to the front 13 and rear 24 footwell zones. A second additional duct 38 is assigned to distributing air jointly to the first and second main ducts 8, 7, via the main splitter 6. Ventilation of the rear seat zone 23 for its part is performed from the second main duct 7.

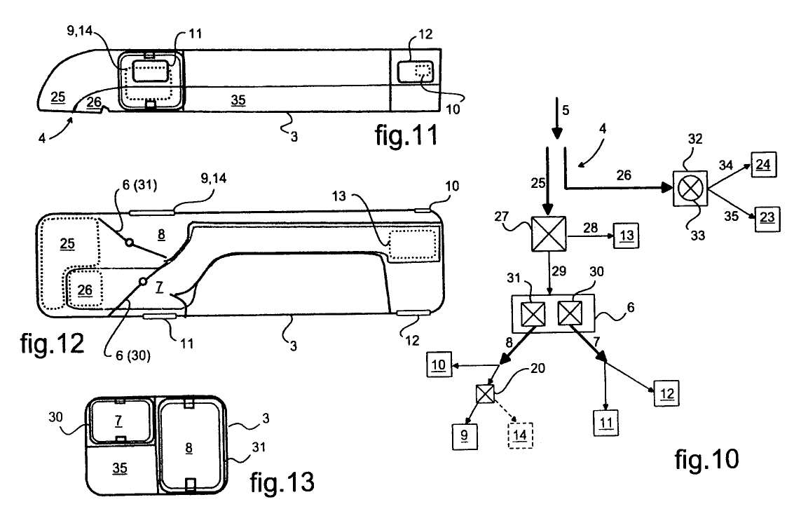

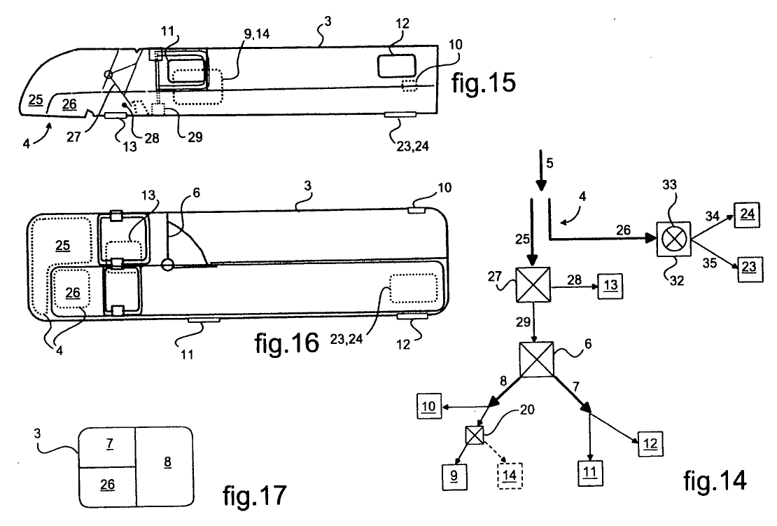

In the embodiment variants illustrated in FIG. 10 to FIG. 13, on the one hand, and in FIG. 14 to FIG. 17 on the other, the overall intake duct 4 is subdivided at least into two elemental ducts 25 and 26 which are respectively assigned, in the case of a first elementary duct 25, to ventilating the various front zones 9, 10, 11, 12, 13 and, in the case of a second elementary duct 26, to ventilating the various rear zones 23 and 24. As a preference, according to these latest variants, the first elementary duct 25 is in communication, via a second splitter 27, selectively with a first intermediate duct 28 assigned to distributing air to the front 13 footwell zones and with a second intermediate duct 29 equipped with said main splitter 6.

In the light of these latest variants it will be noted that, in general, the main splitter 6 can be a single splitter, as illustrated in FIG. 14 to FIG. 17, or alternatively may be subdivided into a first elementary splitter 30 assigned to the second main duct 7 and a second splitter 31 assigned to the first main duct 8, in order alternatively to open and/or close them, just as in the variant illustrated in FIG. 10 to FIG. 13.

Returning to FIG. 1, the box structure 3 is advantageously equipped with means for accommodating it inside a structural element of the cockpit of the vehicle, and more particularly inside a transverse beam 2 that reinforces the cockpit. These means are, for example, means of attachment by screwing, by nesting or other similar means. It will be noted in the embodiment illustrated that the beam 2 is organized as two half sections which are assembled with one another to allow ease of installation of the module 1, particularly the box structure 3. The beam 2 also comprises air passage apertures which are in register with the various air intake and outlet openings of the distribution module.

In the embodiment illustrated, the beam 2 and, generally, a structural element of the cockpit of the vehicle, more particularly comprises:
a first set of at least one window 39 which is formed through its rear wall, directed towards the bulkhead of the cockpit and which is intended to supply air for deicing the windshield 9 and/or gentle diffusion 14,
a second set of apertures 40 formed through its rear wall and intended to supply air for demisting the side windows 10,
a third set of at least one window 41 formed through its underside wall and intended to supply air to the box structure 3,
in addition, a fourth set of apertures 42 formed through its underside wall and intended to distribute air towards the front and rear footwell zones 13 and 24 respectively,
a fifth set of apertures 43 and 44 formed through its front wall and intended to distribute air to the various front seat vent zones 11, 12 of the cockpit respectively, the central ventilation 43 and lateral ventilation 44 in particular and
a sixth set of apertures 45 formed through its underside wall and intended to distribute air towards the rear seat 23 and footwell 24 zones.

In another variant, the second set of apertures 40 is formed in the top wall of the structural element, that is to say directly facing the instrument panel fagade or the windshield of the vehicle.

It will be understood that an instrument panel organized to accommodate a module of the present invention is recognizable in that it comprises measures similar to those which have just been described in relation to the organization of the beam, particularly in respect of the sets of apertures that the beam comprises.

It will be noted that, without deviating from the rules of the invention which have just been set out, the box structure can, with equal preference, be made up of a single box structure or be subdivided into several elementary box structures that collaborate for distributing air to all the zones of the cockpit, and, in particular, into elementary box structures distributed on the right and on the left.

It will also be noted that the box structure is preferably made of injection-molded plastic, polypropylene containing 20% talc, or high crystallinity polypropylene (HCP) in particular, so that it has characteristics both of lightness of weight, which is advantageous, and of appropriate mechanical strength.

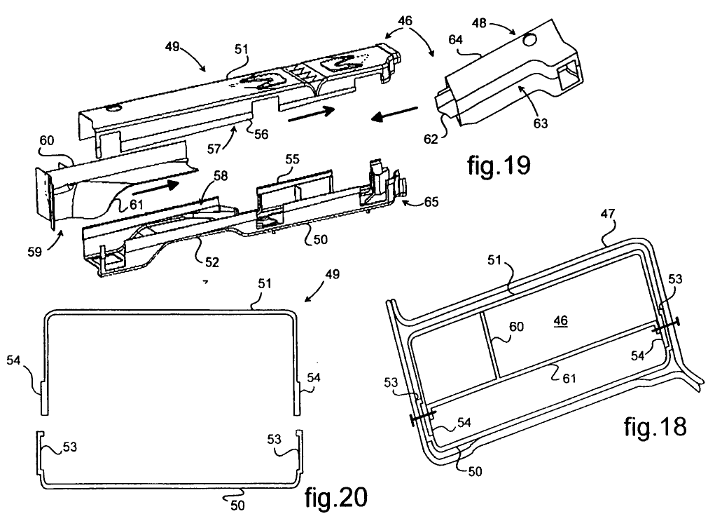

In FIG. 18, a box structure 46 that a module of the present invention comprises is installed within a beam 47 that reinforces the cockpit of the vehicle. In FIG. 19, this box structure 46 is made up of two end elements, right 48 and left 49, which are organized in such a way as to allow them to be mounted inside the beam 47 via the ends thereof. These box structure elements 48 and 49 are each arranged as shells assembled with each other.

Concerning more particularly the left element 49, and in FIG. 19 and FIG. 20, this element is made up of two longitudinal half shells 50 and 51. One, 50, of these half shells has a narrowed region 52 intended for the passage of an obstacle that the beam 47 comprises, such as a recess for the passage of a steering column of the vehicle. This organizing of the element into two half shells 50 and 51 allows the half shell 50 comprising the narrowed region 52 to be introduced into the beam 47 notwithstanding the presence of the obstacle that the latter comprises. Next, once this installation has been performed, the second half shell 51 is then introduced into the beam 47 by sliding along the first half shell 50. The half shells 50 and 51 are assembled with one another by way of a set of slideways 53 and collaborating rails 54 allowing such introduction of the second half shell 51 by sliding, and offering a sealed joint between the half shells 50 and 51. Also in FIG. 19, the longitudinal edges 55 and 56 of the openings 57 and 58 of the half shells 50 and 51 are longitudinally inclined to facilitate the introduction of the second half shell 51 by sliding along the first half shell 50 from the corresponding end of the beam 47.

The half shells are assembled with one another by screwing or the like particularly once they have been nested one upon the other by longitudinal sliding of the half shell 51 along the half shell 50. More particularly, at least one joining element, particularly a screw that has not been depicted, straddles the half shells 50, 51 to fix them together.

According to an advantageous embodiment variant, this assembling of the half shells 50, 51 with one another is performed after they have been introduced into the structural element, from the outside of the latter, so that the element used to join the shells to one another is also an element for joining the shells to the structural element. It is evident that, using one and the same fixing operation, and at least one and the same joining element, not only can the half shells 50, 51 be assembled with one another, but these can also be assembled with the structural element.

In FIG. 19, the left element 49 of the box structure is equipped with an end tip shell 59 for closing of the corresponding end of the box structure. This end tip shell 59 has flanges 60 and 61 intended to extend inside the left element 49 of the box structure to partition it.

As a preference, reinforcements are formed in at least one of the partitioning flanges 60, 61 to accept the joining element at least intended for assembling the half shells with one another and preferably for assembling them with the structural element. These measures are aimed at fixing the partitioning flanges and holding them firmly so as to avoid vibration, all this being achieved in one single assembly operation.

The right element 48 is made up of a shell 64 closed at its right end, which houses an internal partitioning element 62.

The right 48 and left 49 elements each comprise narrowed regions 63 and 65 which open onto their ends that face each other. These narrowed regions 63 and 65 together form a housing to accommodate an airbag.

1. Module for conveying and distributing air originating from a thermal unit of a heating, ventilating and/or air conditioning system system for the cockpit of a vehicle, characterized in that it comprises at least one partitioned box structure (3) which delimits a number of ducts allocated respectively to the supply of air to zones of the cockpit, this box structure (3) delimiting an overall intake duct (4) which is in communication with the thermal unit, and being equipped with at least one main splitter (6) for distributing the admitted air selectively towards main distribution ducts (7, 8) which are in communication via respective outlets with at least one of said zones of the cockpit to which these outlets are assigned.

2. Air conveying and distribution module according to claim 1, characterized in that the main ducts (7, 8) are distributed at least as a first main duct (8) assigned at least to the supply of air for deicing the windshield (9) and for demisting the side windows (10) and a second main duct (7) assigned at least to supplying air to the front zone of the cockpit (11, 12).

3. Air conveying and distribution module according to claim 2, characterized in that the first main duct (8) is also assigned to supplying air for gentle diffusion (14).

4. Air conveying and distribution module according to either one of claims 2 and 3, characterized in that the second main duct (7) is also assigned to supplying air to the rear ventilation zone of the cockpit (13).

5. Air conveying and distribution module according to any one of claims 2 to 4, characterized in that the overall duct (4) is in selective communication, via an additional splitter (36) with additional ducts (37, 38), a first additional duct (37) being assigned to distributing air to front and rear footwell zones (13, 24), and a second additional duct (38) being assigned to distributing air jointly to the first and second main ducts (8, 7) via the main splitter (6), the ventilation of the rear seat zone (23) being performed from the second main duct (7).

6. Air conveying and distribution module according to any one of the preceding claims, characterized in that the overall intake duct (4) is subdivided at least into two elementary ducts (25, 26) assigned respectively, in the case of a first elementary duct (25) to ventilating the various front zones (9, 10, 11, 12, 13) and, in the case of a second elementary duct (26), to ventilating the various rear zones (23, 24).

7. Air conveying and distribution module according to claim 6, characterized in that the first elementary duct (25) is in communication, via a secondary splitter (27), selectively with a first intermediate duct (28) assigned to distributing air toward the front footwell zones (13) and with a second intermediate duct (29) equipped with said main splitter (6).

8. Air conveying and distribution module according to any one of the preceding claims, characterized in that the main splitter (6) is subdivided into a first elementary splitter (30) assigned to the second main duct (7) and a second elementary splitter assigned to the first main duct (8).

9. Air conveying and distribution module according to any one of claims 1 to 8, characterized in that it is equipped with means for accommodating it inside a transverse beam (2) of the cockpit, this beam (2) comprising air passage apertures in register with the various air intake and outlet openings.

10. Air conveying and distribution module according to any one of the preceding claims, characterized in that it is equipped with means for accommodating it inside an instrument panel (2) of the cockpit, with instrument panel (2) comprising air passage apertures in register with the various air intake and outlet openings.

11. Structural element of a cockpit of a vehicle for accommodating an air conveying and distribution module according to any one of claims 1 to 10, characterized in that it is equipped with means for accommodating the box structure within its internal volume, and in that it comprises, through its walls, apertures for the passage of the air, both intake air and outlet air bound for the vents, which are in register with the various ducts that the box structure comprises.

12. Structural element of a cockpit of a vehicle according to claim 11, characterized in that it comprises:
a first set of at least one window (39) which is formed through its rear wall, directed toward the bulkhead of the cockpit and which is intended to supply air for deicing the windshield (9) and gentle diffusion (14),
a second set of apertures (40) formed through its rear wall and intended to supply air for demisting the side windows (10),
a third set of at least one window (41) formed through its underside wall and intended to supply air to the box structure (3),
a fourth set of apertures (42) formed through its underside wall and intended to distribute air towards the front and rear footwell zones (13, 24) respectively,
a fifth set of apertures (43, 44) formed through its front wall and intended to distribute air to the various front seat vent zones (11, 12) of the cockpit respectively, and
a sixth set of apertures (45) formed through its underside wall and intended to distribute air towards the rear seat (23) and footwell (24) zones.

13. Structural element of a cockpit of a vehicle according to claim 11, characterized in that it comprises:
a first set of at least one window (39) which is formed through its rear wall, directed towards the bulkhead of the cockpit and which is intended to supply air for deicing the windshield (9) and gentle diffusion (14),
a second set of apertures (40) formed through its rear wall and intended to supply air for demisting the side windows (10),
a third set of at least one window (41) formed through its underside wall and intended to supply air to the box structure (3),
a fifth set of apertures (43, 44) formed through its front wall and intended to distribute air to the various front seat vent zones (11, 12) of the cockpit respectively, and
a sixth set of apertures (45) formed through its underside wall and intended to distribute air towards the rear seat (23) and footwell (24) zones.

14. Structural element of a cockpit of a vehicle according to any one of claims 11 to 13, characterized in that it is a transverse beam for reinforcing the cockpit of the vehicle.

15. Structural element of a cockpit of a vehicle according to any one of claims 11 and 13, characterized in that it is an instrument panel.

16. Air conveying and distribution module according to any one of the preceding claims, characterized in that since the box structure (46) is organized so as to be housed inside a structural element consisting of a reinforcing beam (47) reinforcing the cockpit of the vehicle, this box structure (46) is made up of a plurality of shells (50, 51, 59, 64) assembled with one another.

17. Air conveying and distribution module according to claim 16, characterized in that the shells (50, 51, 59, 64) are divided into elements these being respectively at least a right end element (48) and a left end element (49), and possibly also a middle element, which are butted together longitudinally.

18. Air conveying and distribution module according to claim 17, characterized in that at least one said element (48, 49) comprises at least one narrowed region (52, 63, 64) for the passage of an obstacle that the beam (47) comprises.

19. Air conveying and distribution module according to claim 18, characterized in that with the narrowed region (52) being situated in a central region of a first element (49), the latter is split into two longitudinally open half shells (50, 51) of which one (50) comprises the narrowed region (52).

20. Air conveying and distribution module according to claim 18, characterized in that the edges (55, 56) of the openings (57, 58) of the half shells (50, 51) are longitudinally inclined.

21. Air conveying and distribution module according to either one of claims 19 and 20, characterized in that the half shells (50, 51) comprise, along the edge of their longitudinal openings, collaborating nesting members (53, 54) for assembling them with one another.

22. Air conveying and distribution module according to claim 21, characterized in that the collaborating nesting members consist of a set of slideways (53) and collaborating rails (54) which are formed respectively along the longitudinal edges of the openings (57, 58) of the half shells (50, 51) to facilitate their relative guidance when they are being assembled.

23. Air conveying and distribution module according to either one of claims 21 and 22, characterized in that the nesting members (53, 54) have collaborating faces that are non-parallel so as to encourage the clamping and leaktightness of the assembly of the half shells (50, 51) with one another.

24. Air conveying and distribution module according to claim 23, characterized in that two adjacent elements (48, 49) comprise a narrowed region (63, 65) that is adjacent from one of the elements (48, 49) to the other so as jointly to delimit a housing for the passage of a part of the vehicle.

25. Air conveying and distribution module according to any one of claims 15 to 24, characterized in that the box structure comprises at least one end tip shell (59) for closing off its corresponding end.

26. Air conveying and distribution module according to claim 23, characterized in that the end tip shell (59) comprises at least one flange (60, 61) for partitioning at least one other shell (50, 51) so as to form at least one internal duct inside the box structure.

27. Air conveying and distribution module according to claim 19, characterized in that the half shells (50, 51) are assembled with one another by a joining element straddling the half shells (50, 51).

28. Air conveying and distribution module according to claim 27, characterized in that the joining element joining the shells (50, 51) to one another is also a joining element joining the shells (50, 51) to the structural element.

29. Air conveying and distribution module according to claims 26 and 27, characterized in that reinforcements are formed in at least one of the partitioning flanges (60, 61) to accept the joining element at least intended for assembling the half shells (50, 51) with one another.
